(19) United States
(12) Patent Application Publication
(10) Pub. No.: US 2020/0384317 A1
(43) Pub. Date: Dec. 10, 2020

(54) LEVER DEVICE FOR LIFTING AND LOWERING ROPE ACCESS CLIMBERS

(71) Applicant: Jeremy Michael Kimble, Kenner, LA (US)

(72) Inventor: Jeremy Michael Kimble, Kenner, LA (US)

(21) Appl. No.: 16/436,231

(22) Filed: Jun. 10, 2019

(51) Int. Cl. A63B 29/02; A62B 99/00

(52) U.S. Cl. CPC A63B 29/02; A62B 99/00

(57) ABSTRACT

A lever device for climbers includes an elongated body having a first end opposite a second end, a length running from the first end to the second end, a first carabiner opening defined at the first end and a second carabiner opening defined at the second end. A cord slot runs along the length from the first end to the second end and terminating at the first end. A cord connector is configured to releasably couple a cord to the second end.

### BACKGROUND OF THE INVENTION

The present invention relates generally to rescuing a climber during rope access and in particular to a device that may be used to easily lift a rescuee while performing a rope access technique.

Rope access is a technique used in climbing and caving, which applies practical ropework to allow climbers to access difficult-to-reach locations. When performing rope access, one climber must be able to rescue another climber from hanging in a weighted position. Current methods of lifting a rescuee involves attempting to physically lift the rescuee or taking additional time to rig a more convenient system. Current methods allow no room for error, require great strength to perform, and create pinch points that may injure the rescuer or rescuee.

As can be seen, there is a need for a device that may be used to easily lift a rescuee when necessary.

### SUMMARY OF THE INVENTION

In one aspect of the present invention, a lever device comprises: an elongated body comprising a first end opposite a second end, a length running from the first end to the second end, a first carabiner opening defined at the first end and a second carabiner opening defined at the second end; a cord slot running along the length from the first end to the second end and terminating at the first end; and a cord connector configured to releasably couple a cord to the second end.

In another aspect of present invention, a method of connecting a lever device to a climbing rig comprises: providing the lever device comprising: an elongated body comprising a first end opposite a second end, a length running from the first end to the second end, a first carabiner opening defined at the first end and a second carabiner opening defined at the second end; a cord slot running along the length from the first end to the second end and terminating at the first end; and a cord connector; coupling a first carabiner to the first carabiner opening and a second carabiner to the second carabiner opening; running a cord through the cord slot so that a first end of the cord protrudes beyond the first end of the elongated body; and releasably connecting a second end of the cord to the second end of the elongated body via the cord connector.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a side view of an embodiment of the present invention;

FIG. 3 is a perspective view of an embodiment of the present invention, shown in use;

FIG. 4 is a perspective view of an embodiment of the present invention, shown in use; and

FIG. 5 is detail perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

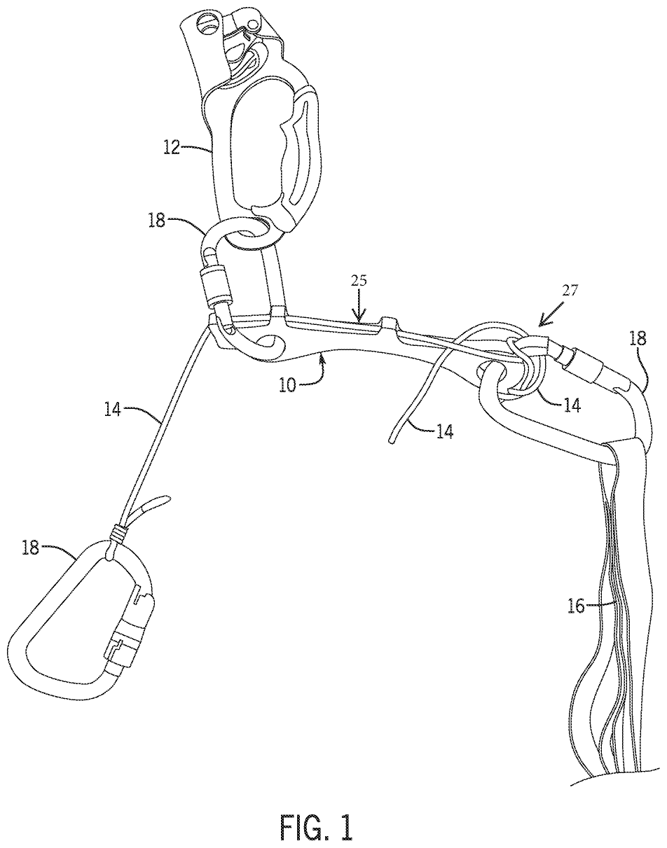

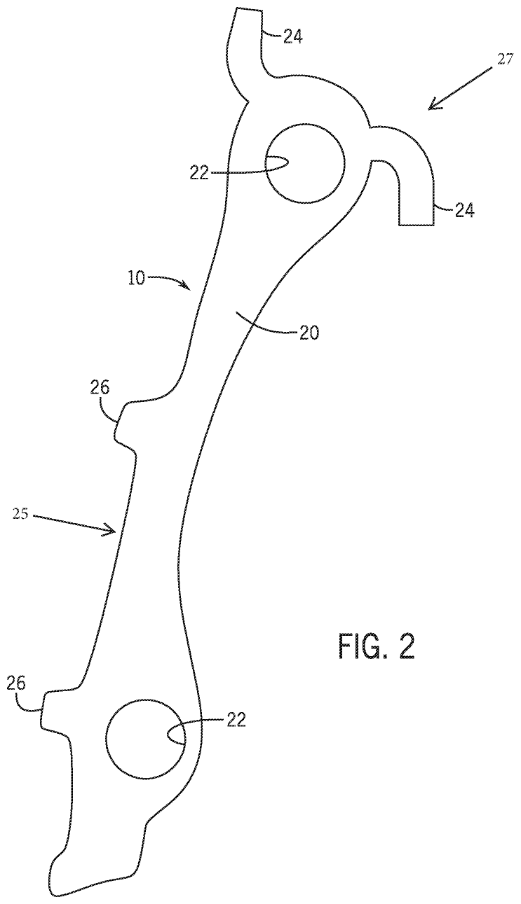

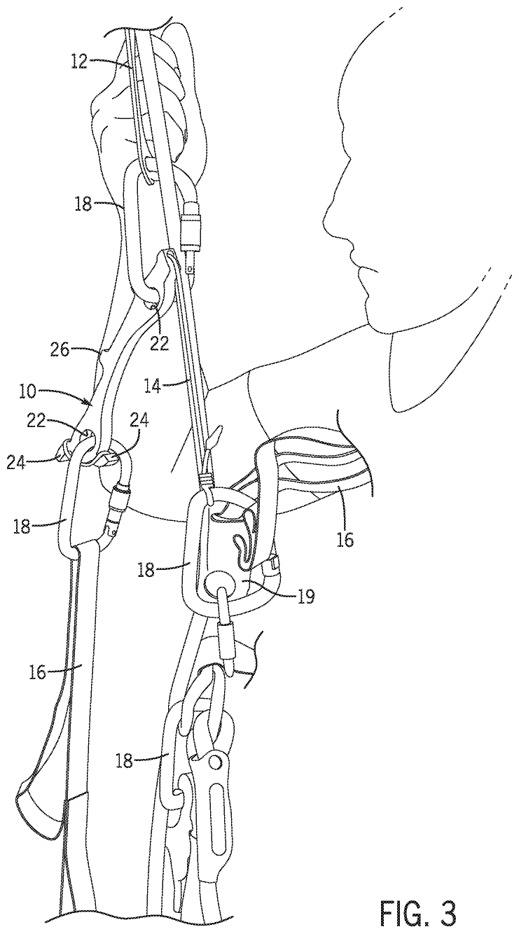

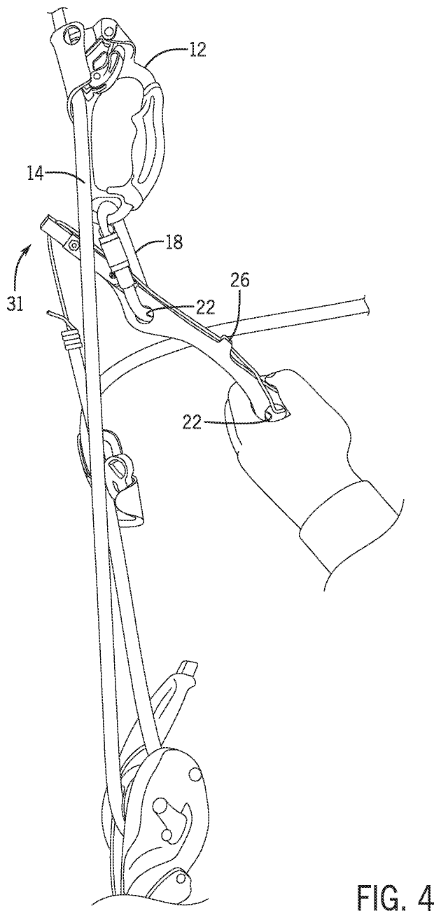

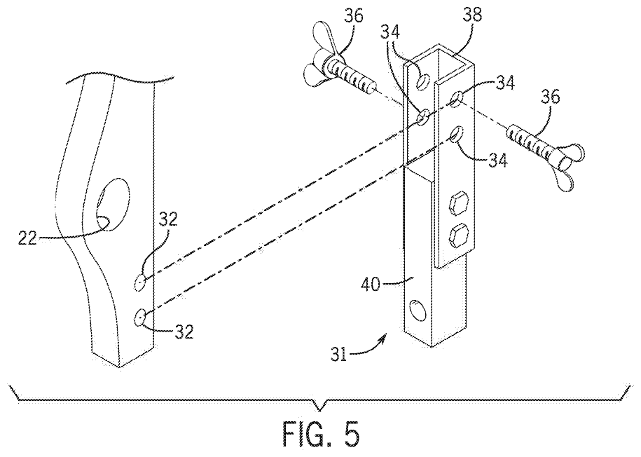

Referring to FIGS. 1 through 5, the present invention includes a lever device 10. The lever device 10 includes an elongated body 20 having a first end opposite a second end, a length running from the first end to the second end, a first carabiner opening 22 defined at the first end and a second carabiner opening 22 defined at the second end. A cord slot 25 runs along the length from the first end to the second end and terminating at the first end. A cord connector 27 is configured to releasably couple a cord 14 to the second end.

In certain embodiments, the elongated body 20 includes an outer edge having an upper portion, a lower portion, a front end and a rear end. The cord slot 25 may defined along an upper portion of the outer edge. For example, a plurality of bosses 26 protrudes from the upper portion of the outer edge. Each of the plurality of bosses 26 includes an opening aligned with one another to define the cord slot 25. The cord 14 runs through the cord slot 25 and hangs beyond the front end of the elongated body 20.

The cord connector 27 may include a first bent prong 24 extending from an upper portion of an outer edge of the elongated body 20 at the rear end and a second bent prong 24 extending from a lower portion of an outer edge of the elongated body at the rear end bending in an opposite direction of the first bent prong 24. To releasably secure the cord 14 to the second end of the elongated body, a user may wrap the cord 14 around each of the first and second bent prongs 24.

To add leverage, the present invention may further include an extension 31. The extension 31 may include a block 40 disposed within a channel bracket 38. The block 40 may be releasably coupled to the channel bracket 38 and adjusted to extend or retract a length of the extension 31. The channel bracket 38 may further include clearance holes 34 that align with mounting holes 32 defined at the first end of the elongated body 12. The extension 31 is coupled to the elongated body 12 by aligning the mounting holes 32 with the clearance holes 34 and inserting bolts 36 through the aligned holes 32, 34. The extension adds additional leverage to the present invention.

A method of connecting a lever device 10 to a climbing rig may include the following steps: provide the lever device 10 described above; couple a first carabiner 18 to the first carabiner opening 22 and a second carabiner 18 to the second carabiner opening 22; run a cord 14 through the cord slot 25 so that a first end of the cord 14 protrudes beyond the first end of the elongated body 12; releasably connect a second end of the cord 14 to the second end of the elongated body 12 by wrapping the second end of the cord 14 around the first and second bent prongs 24; couple the first carabiner 18 to a rope grab 12; couple the second carabiner 18 to foot loop straps 16; couple a third carabiner 18 to the first end of the cord 14; couple the third carabiner 18 to a chest ascender 19 of a rescuee so that the lever device 10 is in a vertical position with the second end pointing upward; and urge the second end of the lever device 10 to pivot downwards, thereby lifting the rescuee upwards. The second end may be urged downwards by either arm strength or the weight of a user's body.

It should be understood, of course, that the foregoing relates to exemplary embodiments of the invention and that modifications may be made without departing from the spirit and scope of the invention as set forth in the following claims.

What is claimed is:

1. A lever device comprising:
an elongated body comprising a first end opposite a second end, a length running from the first end to the second end, a first carabiner opening defined at the first end and a second carabiner opening defined at the second end;
a cord slot running along the length from the first end to the second end and terminating at the first end; and
a cord connector configured to releasably couple a cord to the second end.

2. The lever device of claim 1, wherein the elongated body comprises an outer edge.

3. The lever device of claim 2, wherein the cord slot is defined along an upper portion of the outer edge.

4. The lever device of claim 3, further comprising a plurality of bosses protruding from the upper portion of the outer edge, each of the plurality of bosses comprises an opening aligned with one another to define the cord slot.

5. The lever device of claim 1, wherein the cord connector comprises a first bent prong extending from an upper portion of an outer edge of the elongated body and a second bent prong extending from a lower portion of an outer edge of the elongated body bending in an opposite direction of the first bent prong.

6. A method of connecting a lever device to a climbing rig comprising:
providing the lever device comprising:
an elongated body comprising a first end opposite a second end, a length running from the first end to the second end, a first carabiner opening defined at the first end and a second carabiner opening defined at the second end;
a cord slot running along the length from the first end to the second end and terminating at the first end; and
a cord connector;
coupling a first carabiner to the first carabiner opening and a second carabiner to the second carabiner opening;
running a cord through the cord slot so that a first end of the cord protrudes beyond the first end of the elongated body; and
releasably connecting a second end of the cord to the second end of the elongated body via the cord connector.

7. The method of claim 6, further comprising
coupling the first carabiner to a rope grab.

8. The method of claim 7, further comprising
coupling the second carabiner to foot loop straps.

9. The method of claim 8, further comprising
coupling a third carabiner to the first end of the cord; and
coupling the third carabiner to a rescuee, wherein the lever device is in a vertical position with the second end pointing upward.

10. The method of claim 9, further comprising
urging the second end of the lever device to pivot downwards, thereby lifting the rescuee upwards.
